(19) United States
(12) Patent Application Publication
(10) Pub. No.: US 2011/0116514 A1
(43) Pub. Date: May 19, 2011

(54) COMMUNICATION SYSTEM WITH NESTABLE DELIMITED STREAMS

(76) Inventor: Evan R. Kirshenbaum, Mountain View, CA (US)

(21) Appl. No.: 12/618,569

(22) Filed: Nov. 13, 2009

(51) Int. Cl. H04J 3/22

(52) U.S. Cl. 370/472

(57) ABSTRACT

A communication system is adapted for communicating data in nestable delimited streams with support for abort and overlays. The communication system comprises a communication channel that communicates a data stream in multiple delimited streams. The individual delimited streams are delimited by a prefix formed of a delimiter which is generated specific to the data segment and a postfix formed of the generated delimiter followed by a CLOSED indicator. The communication channel nests a second delimited stream within a first delimited stream of the multiple data segments.

### BACKGROUND

A data communication system is formed of communication, computation, and data processing devices connected by a network of transmission links. Information is communicated among the devices over the transmission links in a serial stream containing both data and control information, including notation of the beginning and end of a stream. The data and control information are merged into communication elements called frames.

### BRIEF DESCRIPTION OF THE DRAWINGS

Embodiments of the invention relating to both structure and method of operation may best be understood by referring to the following description and accompanying drawings:

FIG. 1 is a schematic block diagram illustrating an example embodiment of a communication system adapted for communicating data in nestable delimited streams with support for abort and overlays

FIGS. 2A through 2G are data structure diagrams showing examples of delimited streams;

FIGS. 3A through 3E are flow charts depicting aspects and embodiments of example methods for managing data communication;

FIG. 4 is a schematic block diagram showing another example embodiment of a communication system which supports nestable delimited streams with abort and overlays;

FIGS. 5A through 5E are data diagrams illustrating a series of data values in a data stream in an example operation; and

FIG. 6 is a block and data structure diagram showing an example embodiment of the illustrative communication method for forming a chain of writer objects that create nested data streams and a chain of reader objects that can consume the streams.

### DETAILED DESCRIPTION

Computer processes communicating with one another typically do so by use of communication channels such as sockets. The channels are formed of streams of bytes written by one side and read by the other. Typically a communication channel has one such stream passing in each direction. One side is typically a client which sends requests to the other side (a server) according to a protocol which specifies the structure of the data that accompanies the request. The server computes and sends back a response along the other channel. In some protocols, the two sides may occasionally temporarily exchange roles.

Several difficulties are inherent in data stream communication. For example, a reader and writer of the data stream must be able to determine when one request or response ends and another begins. Similarly, the data stream reader and writer also determine when individual elements of data sent along with a request or response end and begin, particularly in conditions that data (such as strings or sequences) may have a size unknown to the recipient. In many systems, the server must be able to deal with unanticipated requests for which the server only has limited understanding of the data, typically that the server does not understand, will not be able to understand, and are best handled by skipping the request and sending a response indicating the lack of understanding. Similarly, the client is to handle previously unknown responses from the server. Another problem is that typically a request can either succeed (with some response) or fail, with an indication of reason for failure and perhaps some data associated with the failure (or partial success). Some technique for indicating the failure is desired, in a manner that does not adversely affect system performance. A further difficulty is that, in addition to requests and responses, it may be beneficial for one side to be able to send other higher-priority asynchronous messages to the other side for use in managing the connection or other reasons. As with requests and responses, the system must be prepared to deal with incapacity to understand the messages.

Several techniques can be used to determine the end of a message or the end of a data element within a message. The various techniques can be used independently but can also be used in combination. In one technique, the end of message or data element can cause closure of the underlying connection. Thus, when a socket is closed (either explicitly or by the process on the other side going away), the underlying streams are closed and the reader receives an exception or an indication of an end-of-file condition when the reader attempts to read. Typically data that has already been sent is consumed first. Systems using the technique often have a single request and response sent along a connection. An example is HyperText Transfer Protocol (HTTP). Many servers that take multiple requests use the stream closure technique for handling the question “Are there any more requests?” A disadvantage of the stream closure approach is a relatively high expense in forming connections and establishing an appropriate context.

Another approach uses the protocol to determine where one message or data element ends and the next begins. If the arguments to a request (or the contents of a record) are two integers, a string, and an array of Booleans, the reader will read the four elements and know that the data element is finished. A main problem with the technique is that a reader which for some reason does not know what data to expect (such as when receiving an unfamiliar request), is unable to know how many bytes to consume uninterpreted in order to be able to resynchronize. Also, if some of the data elements have variable size (such as strings, arrays, sets, or sequences); some mechanism will have to be employed in order for the reader to be able to read them.

A further approach involves supplying to the reader an indication of the size of data to follow, typically in one of two forms: either a number of bytes to follow in the representation of a message or structure, or the number of substructures (as the case of a sequence or array). Indicating the number of bytes makes straightforward the skipping of uninterpretable requests. Both forms have the disadvantage that the answer must be computed ahead of time. For the number of bytes, the computation is typically done in several ways. First, the answer is fixed for the particular request or response and therefore known to the writer (and if assumed to be known to the reader, often omitted from the actual transmitted data). Fixing the answer is not sufficiently flexible. Second, the data can be written to an intermediate buffer in the writer's process, determining how much was written, and then writing the buffer to the stream. Writing data to the intermediate buffer can require potentially unbounded space on the writer's side, involves extra work to copy the buffer to the stream, and does not allow the reader to see any data until the writer is finished writing everything. Third, the computation can be made in two passes, a first pass to request the amount of space required for the representation of the data and a second pass to write the data. Computing the number of bytes in two passes is inefficient, involving extra work and may require the writer to either perform the work twice or cache answers between the first and second questions. Furthermore, cached information may accrete if the second question never is asked, causing memory management problems.

An additional approach uses a delimiter which is a distinguished byte or sequence of bytes (or, sometimes, some other distinguished value) which indicates the end of a data element or message. Examples of delimiters are the null character used to delimit strings, the carriage return/line feed combination used to delimit text lines, the single period at the beginning of a line used to delimit e-mail messages on an SMTP connection, or the blank line delimiting the headers in an e-mail message or an HTTP request. A significant problem with using delimiters is dealing with the situation in which the delimiter actually occurs in the data being delimited. In some systems (for example, HTTP headers), the protocol prohibits a delimiter within the data, but in others, the data element which can be confused with the delimiter has to be altered in some way to indicate to the reader not to treat the element as a delimiter. A common way to distinguish the data is to “escape” the delimiter by prefixing an escape character such as a backslash, creating the secondary problem of distinguishing the escape character in the data, which then is also “escaped”. When streams nest, usage of delimiters can thus cause significant interpretation problems. If the delimiter for a stream is, for example, “*” and the escape character is “\”, then to send an asterisk, the stream (or, in many cases, the writer) would change the “*” into “\*”. If that stream were nested inside another stream, both characters would have to be escaped, resulting in “\\\*”. If three streams are involved, the next level would see “\\\\\\\*”. Another method is to alter and thus distinguish or remove the delimiter. For example, HyperText Markup Language (HTML) text is delimited by tags, which begin with “<”. The symbol is allowed in text by transforming into “&gt;”, which may however also be valid data in text. A real ampersand must be written as “&amp;” (meaning that “&gt;” would be transformed to “&amp;gt;”).

To indicate success or failure of a request, sending the response can be delayed until status is certain and then including some sort of an indication, typically in the form of a “response code”, such as HTTP's “200” for “success” and “404” for “not found”. The technique has the same problems as having to compute the size of the request. Intermediate storage may be needed if whether the request is going to be successful is initially uncertain. Additionally, the recipient cannot begin processing the response until the sender has finished computing status. Also, a sender that changes status partway through processing (as when a file assumed to be available is no longer present when a read is attempted or when an exception occurs while writing the response), has no way to indicate the error status other than simply dropping the connection.

Typically, messages beneficially sent asynchronously are sent on the communication channels either by making the messages synchronous (for example by sending between other messages) or by allocating a separate channel for asynchronous usage. Messages made synchronous may be arbitrarily delayed and cannot be used to modify the current transmission. Allocating a separate channel creates more work, requires that the recipient needs are multithreaded, and creates difficulty in correlating the messages with any particular context.

Embodiments of a communication system are adapted for communicating data in nestable delimited streams with support for abort and overlays. The communication system comprises a communication channel that generates a delimited-stream-specific delimiter, indicates a beginning of a delimited stream in a data stream by writing in the data stream the delimited-stream-specific delimiter, and writes content of the delimited stream to the data stream. The communication channel terminates the delimited stream by writing in the data stream the delimited-stream-specific delimiter followed by an indicator of end of the delimited stream.

A system improves data communication by enabling nestable delimited streams with capability to abort and support of overlays.

A communication system includes a stream handler which can be used, for example, for socket-based protocols. The data streams are self-delimiting (and therefore portions of their content can be skipped, to simplify protocol mismatches) and nestable (to simplify the transmission of unknown-size data), and contain logic for aborting in-process data in a way that can be handled remotely and for using the same channel for high-priority asynchronous “overlay” messages.

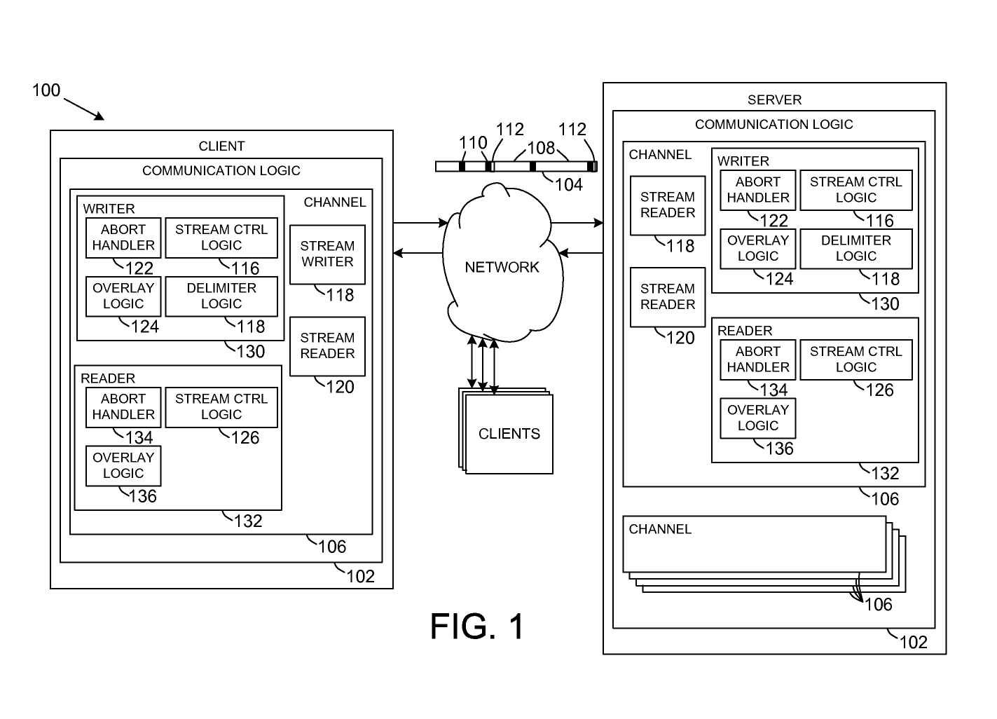

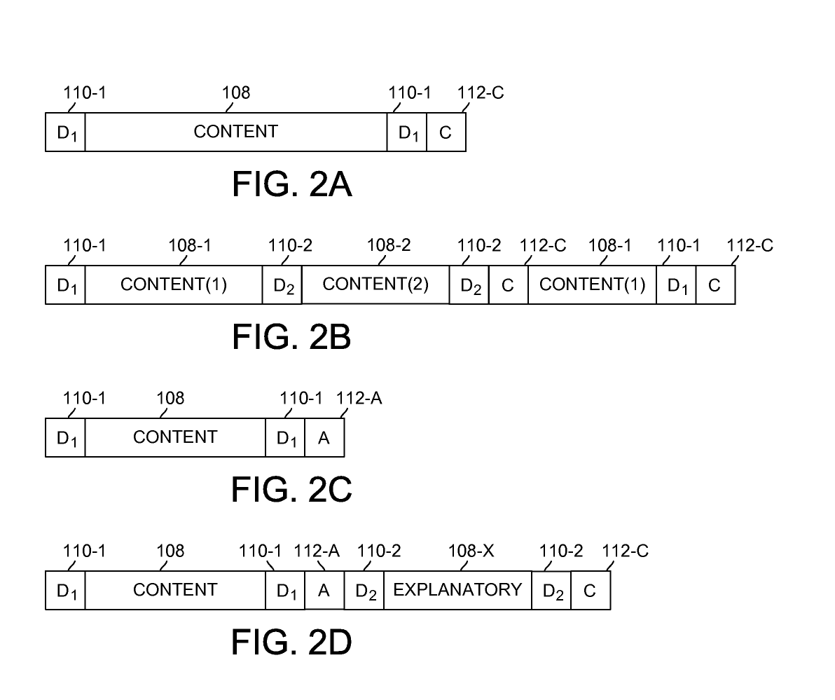

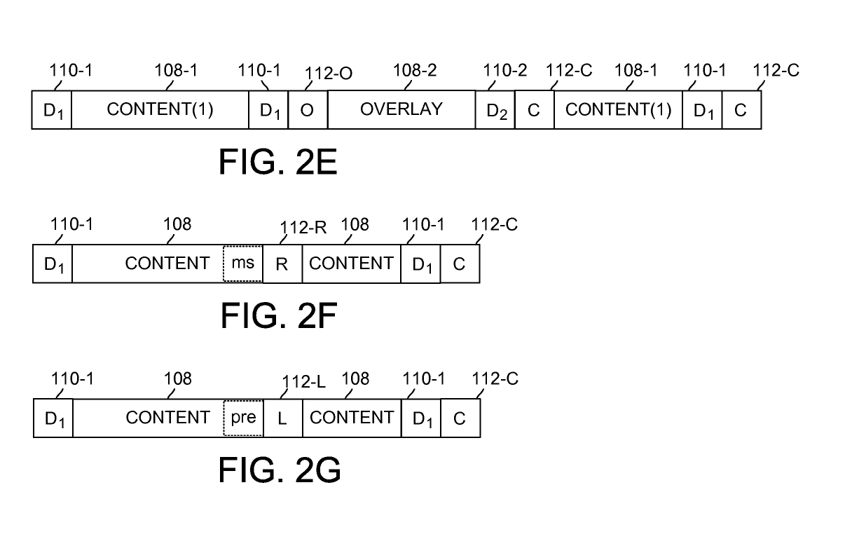

Referring to FIG. 1, a schematic block diagram illustrates an embodiment of a communication system 100 that communicates data in nestable delimited streams with support for abort and overlays. The communication system 100 comprises a communication channel 106 that generates a delimited-stream-specific delimiter (110-1), indicates a beginning of a delimited stream 108 in a data stream by writing in the data stream the delimited-stream-specific delimiter (110-1), and writes content of the delimited stream 108 to the data stream. The communication channel 106 terminates the delimited stream by writing in the data stream the delimited-stream-specific delimiter (110-1) followed by an indicator (112-C) of end of the delimited stream (for example a CLOSED indicator), as shown by data structure diagram in FIG. 2A.

In this description a “data stream” is any sequence of bytes, words, numbers, or other data used for representing or communicating data. A data stream logically has a beginning and an end, which may be explicit or implicit, and data communicated between these points comprises the content of the data stream. (As described below, it may be possible for data communicated between these points to not be considered part of the data stream's content.) A communication channel is a mechanism by which data is transmitted between computers, between processes within a computer, between a computer and a storage device, between a computer and an input or output device, or otherwise, within a computer system. The data communicated on a communication channel constitutes a data stream. The content of a data stream may include one or more other data streams in a nested and/or sequential manner. When a first data stream is nested within a second data stream, the second data stream is said to be the “underlying data stream” of the first. When a data stream is nested, perhaps recursively, within a communication channel, that channel is said to be the “underlying communication channel” of the data stream.

A data stream may impose a reversible transformation on its content, e.g., to compress or encrypt it. In such a case, the content of a data stream is considered to be the content before such transformation is performed or, equivalently, after the reverse transformation is performed. In particular, the statement that a particular sequence of bytes is written to a data stream should be understood to imply that an equivalent sequence of bytes may be read from the data stream (or its communicated analogue, e.g., in another process) but not that that particular sequence of bytes will appear on a communication channel.

A “delimited stream” (or “delimited data stream” or “self-delimiting stream”) is a data stream whose format is specified by this description.

The delimiters 110 are typically short sequences of bytes generated in a manner to make collision with data content reasonably unlikely, such as by accessing a random number source, using pseudo-random number generator, observing unpredictable behavior such as user mouse movements or message arrival times, or computing a cryptographic hash of a varying property such as the current time or the position in a communication channel. For example, the delimiters 110 can be generated by taking a cryptographic hash of a sufficiently precise notion of the current time.

Referring to FIG. 1 in combination with a data structure diagram shown in FIG. 2B, the content of a first delimited stream 108-1 can include a nested second delimited stream 108-2, wherein the second delimited stream 108-2 can be prefixed by a second generated delimiter 110-2 and terminated by the second delimiter 110-2 followed by the CLOSED indicator 112-C.

A delimited stream 108 may indicate that its content is incomplete due to premature termination of its construction. This is indicated by the partial content followed by the first delimiter 110-1 followed by an ABORTED indicator 112-A as shown in FIG. 2C.

The ABORTED indicator 112-A can be followed by explanatory content 108-X indicating a reason for the premature termination. As shown in FIG. 2D, the explanatory content 108-X can be configured as a second delimited stream using a second generated delimiter 110-2.

Thus the streams 104 are abortable. A writer 130 can at any point close the stream and send a description of the reason for the abort, which is automatically handled on the reader's side. The reader 132 need not be able to understand (for example, know the format of data accompanying) the reason.

Communication logic 102 can thus be configured to form self-delimiting streams wherein knowledge of message size before sending is unnecessary and a reader 132 of a message can skip beyond stream end in problem conditions during reading.

The communication logic 102 can nest delimited streams within a delimited stream 104 so that data elements of unknown size are nested within data elements of unknown size.

The delimiters are formed such that the delimited streams 104 can efficiently nest, with negligible (for practical purposes, nonexistent) added quoting being necessary. Quoting used is added automatically so that the same technique can be used to send data of unknown size (perhaps further containing data of unknown size) within a message.

The self-delimiting and nesting features are also useful for externalized forms such as files.

In some embodiments, for example as shown in FIG. 2E, a delimited stream 108-1 may contain within it a second delimited stream 108-2 which is intended and interpreted as an asynchronous overlay message rather than as part of the content of the first delimited stream. Such an asynchronous overlay message is indicated by the presence of the first delimiter 110-1 followed by an OVERLAY indicator 112-0 further followed by a second delimited stream 108-2 using a second generated delimiter 110-2 wherein data content of the first delimited stream 108-1 resumes following the second delimited stream 108-2. The writer 130 may overlay a message on the stream 104. The overlaid message is immediately (approximately) handled by the reader 132, but may be skipped if the reader 132 does not understand the message. The reader 132 need not be multithreaded to use overlays. Overlays may be used for any reason, but an important use is to modify context for the current stream or session. For example, an overlay may be used to indicate the character set used for data that follows or the principal used for encrypting data (indicating for whom the encryption is intended and, therefore, an indication of which key to use to encrypt or decrypt).

The communication system 100 can further comprise a delimited stream writer 118 operatively coupled to the underlying data stream of the delimited stream 108. The delimited stream writer generates the first delimiter 110-1 and writes it to the underlying data stream, terminates the delimited stream 108 upon closure by writing the delimiter 110-1 followed by a CLOSED indicator 112-C, and processes requests to write data content to the delimited stream 108. Processing of the requests can comprise perceiving matches between written data content and the first delimiter 110-1.

The delimited stream writer 118 can indicate premature termination of the delimited stream 108 upon detection of the condition.

The delimited stream writer 118 can also insert an asynchronous message into the delimited stream 108 when appropriate.

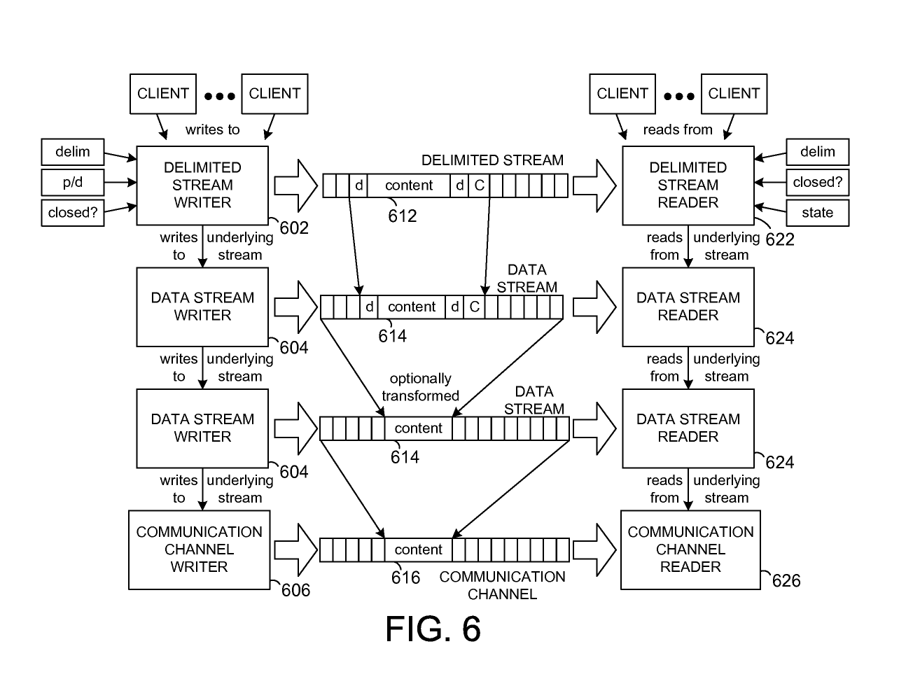

In an example implementation, communication logic 102 can include a delimited stream writer 118 for constructing a delimited stream 108, the delimited stream writer 118 supporting a byte write method and a close method, which will be further described below. The technique for data communication can be used to form a chain of writer objects that can create each of multiple nested data streams (including optional transformations and additions), and a chain of reader objects that reverse the transformations and interpret the data as shown in FIG. 6. The writer objects include delimited stream writers 602, other data stream writers 604, and communication channel writers 608 that respectively write to delimited streams 612, data streams 614, and communication channels 616. The reader objects include delimited stream readers 622, data stream readers 624, and communication channel reader 628. The delimited stream writer 118 can contain data including a reference to an output stream object capable of writing data to the underlying data stream of the delimited stream 108, a delimiter configured as an array of bytes, a position-in-delimiter (PID) indicator, and a Boolean variable designating whether the data stream has been closed. Output stream control logic 116 can construct a delimited stream writer, and form into the delimited output stream a reference to a writer for the delimited stream's underlying data stream. The output stream control logic 116 can generate a delimiter, initialize the PID indicator, set the Boolean to indicate the data stream has not been closed, and write the delimiter to the underlying data stream. The supplied output stream writer may write a delimited stream as disclosed in this description or may be another type of data stream. In some embodiments, a delimited output stream may be considered to be an instance of a class that is a subclass of a more general output stream class.

The communication logic 102 can further include a set of indicators, which in some embodiments are well-known byte values that may be written on underlying data streams. Each of these indicators will have a distinct value. Among the indicators, the communication logic 102 may include a CLOSED indicator, an ABORTED indicator, an OVERLAY indicator, and ALL REAL, indicator, a ONE REAL indicator, a TWO REAL indicator, a THREE REAL indicator, and an N REAL indicator, the uses of which will be detailed below. In some embodiments, indicators may consist of multiple bytes or portions of bytes. In some embodiments, different indicators may have different representations. References to, e.g., a “CLOSED byte”, should be taken to refer to the respective indicator even when said indicator is represented other than as a single byte. Similarly, references to “control bytes” should be taken to refer to indicators regardless of representation.

The output stream control logic 116 can operate on closure of the delimited stream (i.e., a request to execute the delimited output stream's close method) to ensure that the delimited stream has not already been closed. If not already closed, the output stream control logic 116 writes the delimiter to the underlying data stream followed by a CLOSED indicator.

In case the delimited stream 108 contains a data content sequence that matches the first delimiter 110-1 (D₁), this is indicated by on the underlying data stream by the matching data content (110-1 (D₁)) followed by an ALL REAL indicator 112-R which is not considered data content into the delimited stream 108 as shown in FIG. 2F.

In some embodiments and in some situations as depicted in FIG. 2G, the presence of the first delimiter 110-1 followed by an length indicator 112-L indicates that the delimited stream contains, at that point, a prefix of the delimiter 110-1, the length of the prefix specified by the length indicator 112-L, which may specify it directly or by reference to a following byte or bytes. For example, the data stream may be a sequence including content, then the delimiter, then the length indicator, followed by more content before a final delimiter and CLOSED indicator. If the delimiter is TQS and a “length=2” indicator is “2”, then the sequence “TQS2” would be read as “content of TQ” (the first two bytes of the delimiter). The example data stream occurs only in exceptional situations such as when the delimited stream is flushed immediately following the writing of “TQ”. In a normal case such marking is unnecessary since the byte following the content “TQ” is sufficient to identify that “TQ” are to be read as content and not the first two bytes of the delimiter. In some embodiments, the ALL REAL indicator 112-R may be a length indicator 112-L indicating a length equal to the length of the delimiter.

In some embodiments, when an indicator follows a delimiter, some or all of the indicator may occupy the same byte as some of the delimiter. For example, as the CLOSED indicator is the most commonly encountered indicator, in some embodiments, the final byte of the delimiter may be considered to comprise only the seven least-significant bits, with the CLOSED indicator being taken to be the presence of a “one” bit in the high-order bit of the last byte of the delimiter and any other indicators taken to be the byte or bytes following a delimiter whose last byte has a “zero” bit in the high-order bit. In such an embodiment, content matches the delimiter regardless of the value of the high-order bit in the last byte. Further, in such an embodiment, when content matches the delimiter and the last byte has a “one” in the high-order bit, that one is transformed to a “zero” and the delimiter is followed by an ALL REAL HIGH BIT ONE indicator, which indicates that the reader should change the high bit of the final byte to be a “one” bit. In other embodiments, different numbers of bits or different identified bits of the last byte may be used to encode indicators and different indicators may be identified with different bit patterns.

Output stream control logic 116 can operate on request to write a byte to the delimited stream by ensuring that the delimited stream has not already been closed and generating an exception (or otherwise signaling) if already closed. If the delimited stream is not already closed, the output stream control logic 116 writes the byte to the underlying data stream and checks the delimiter and PID indicator to enable the logic 116 to determine whether writing the byte, in the context of preceding written bytes, has resulted in writing a complete delimiter contained within the data the logic 116 has been requested to write. When this happens, the output stream control logic 116 writes an ALL REAL indicator to the data stream.

The communication system 100 can further comprise a delimited stream reader 120 operatively coupled to the communication channel that reads the delimited stream 108. The delimited stream reader 120 can operate by obtaining the first delimiter 110-1 prefixed to the delimited stream 108 and reading content from the delimited stream 108. The delimited stream reader 120 detects and responds to matches between the content and the first delimiter as directed by an indicator that follows in the content. Upon detection of a CLOSED indicator 112-C, the delimited stream reader 120 responds by determining that the delimited stream has no more data content. Upon detection of an ALL REAL indicator 112-R, the delimited stream reader 120 responds by regarding the content which matches the first delimiter 110-1 as data content. Upon detection of a request to read data content, the delimited stream reader 120 responds by supplying successive pieces of read data content of the delimited stream. Upon detection of a closure request, the delimited stream reader 120 responds by processing content in the delimited stream 108 until the delimited stream includes no more data content and the delimiter 110-1 and CLOSED indicator 112-C have been detected and removed from the underlying data stream.

The delimited stream reader 120 can also detect and respond to an ABORTED indicator 112-A by determining that the delimited stream 108 includes no more data content, identifying an abort handler, and using the abort handler to process explanatory content regarding a premature termination of the delimited stream 108.

The delimited stream reader 120 can also detect and respond to an OVERLAY indicator 112-0 by identifying an overlay handler, and using the overlay handler to process an asynchronous message in the delimited stream 108.

In an example embodiment, communication logic 102 can further include input stream control logic 126 comprising a read process that reads a byte and indicates end-of-file when there are no further bytes in the content of the delimited stream 108, and a close process which consumes and ignores remaining bytes, positioning the underlying data stream to read what follows.

In the example implementation, the input stream control logic 126 can construct a delimited input stream on a data stream including the actions of reading a delimiter, tracking to determine data stream status and position of delimiters.

The input stream control logic 126 can read a byte from the delimited stream by determining whether the delimited stream is closed, determining delimited stream status, and reading a byte from the underlying data stream in normal status conditions. The input stream control logic 126 determines whether the byte matches the first byte of the delimiter, returning the byte if there is no match and reading a delimiter prefix otherwise. The input stream control logic 126 reads a delimiter prefix by reading successive bytes from the underlying data stream and determining whether they match successive bytes of the delimiter. If fewer than all of the read bytes match those of the delimiter, the input stream control logic 126 records a representation of the bytes read and sets the delimited stream status to return those bytes, in sequence, upon successive requests to read a byte. It then returns the first read byte. If all of the read bytes match those of the delimiter, the input control logic 126 reads an indicator 112 from the underlying stream. If this indicator indicates that some or all of the read bytes should be considered to be data content of the delimited stream, the input control logic 126 records a representation of the bytes that should be returned on successive requests to read a byte and returns the first read byte.

The communication logic 102 can further include a stream abort handler 122 which is operative in a writer 130 of a communication channel 106 and writes a delimiter to the underlying data stream followed by an ABORTED indicator, marks the data stream as closed, creates a new delimited stream on the underlying data stream, and passes this new delimited stream to a callback object provided by an originator of an abort, requesting that this callback object write on the new delimited stream a description of a reason for the abort. When the callback object finishes, the new delimited stream is closed. In a reader 132 of the communication channel, stream control logic 126 reads the delimiter in the delimited stream and recognizes the ABORTED indicator. The stream control logic 126 considers any further reads of the closed data stream as past end-of-file. Stream abort logic then constructs a reader for a new delimited stream on the underlying stream, checks for an abort handler 134 and if one is present invokes the abort handler the new delimited stream as a parameter. When the abort handler 134 returns or if no abort handler is available, the abort logic closes the new delimited stream, resulting in the underlying stream being positioned past the end of the new delimited stream. The stream control logic 126 then returns an end-of-file indication.

In some embodiments, if the ABORTED indicator is detected during an attempt to skip past the end of the delimited stream, the stream abort logic does not attempt to identify an abort handler but merely creates and closes the new delimited stream, thereby skipping past it on the underlying stream.

The communication logic 102 can also include overlay logic 124, 136 that forms overlays on the delimited stream and can pass multiple overlays on a single delimited stream concurrently. In a writer 130 of a communication channel 106, the overlay logic 124 writes a delimiter to the underlying data stream followed by an OVERLAY indicator, then creates a new delimited stream on the delimited stream and passes this new delimited stream to a callback writer object which writes data to the new delimited stream. When the callback writer returns, the new delimited stream is closed and the stream control logic 116 continues writing the content of the original delimited stream. In a reader 132 of the communication channel, the control logic 126 recognizes the delimiter in the delimited stream and recognizes the OVERLAY indicator. Stream overlay logic 136 then constructs a reader for a new delimited stream on the underlying stream, checks for an overlay handler and if one is present invokes the overlay handler the new delimited stream as a parameter. When the overlay handler returns or if there is no overlay handler the overlay logic 136 closes the new delimited stream, resulting in the underlying stream being positioned past the end of the new delimited stream. The stream control logic 126 then proceeds to read data content of the original delimited stream.

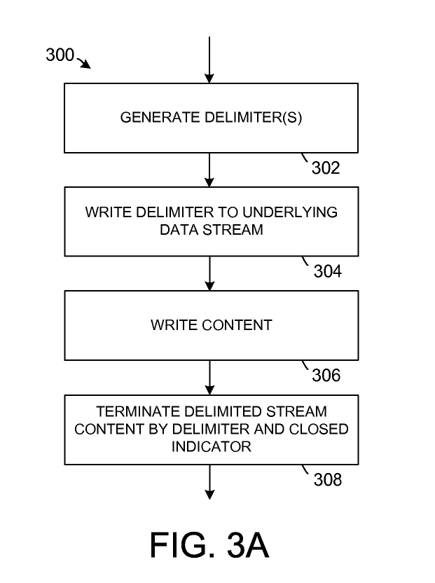

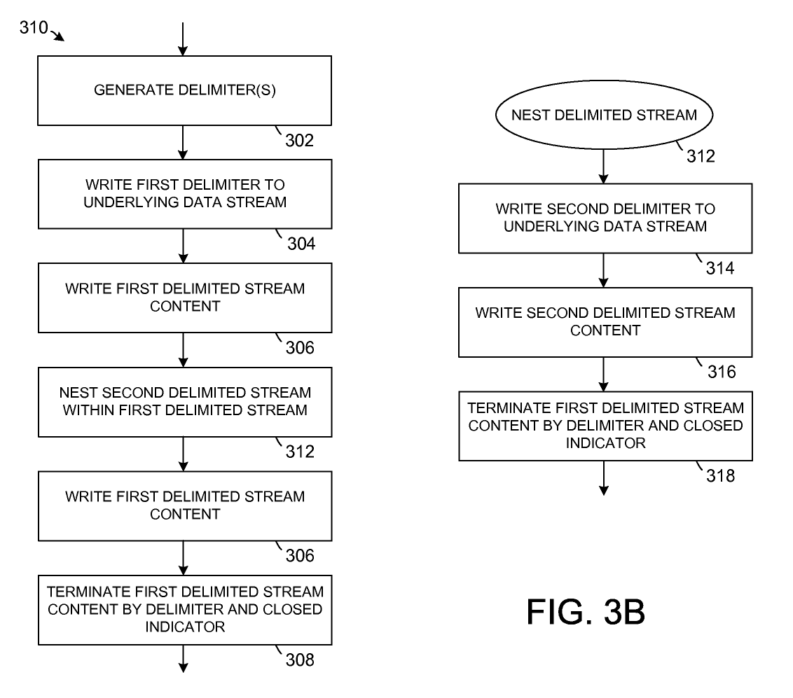

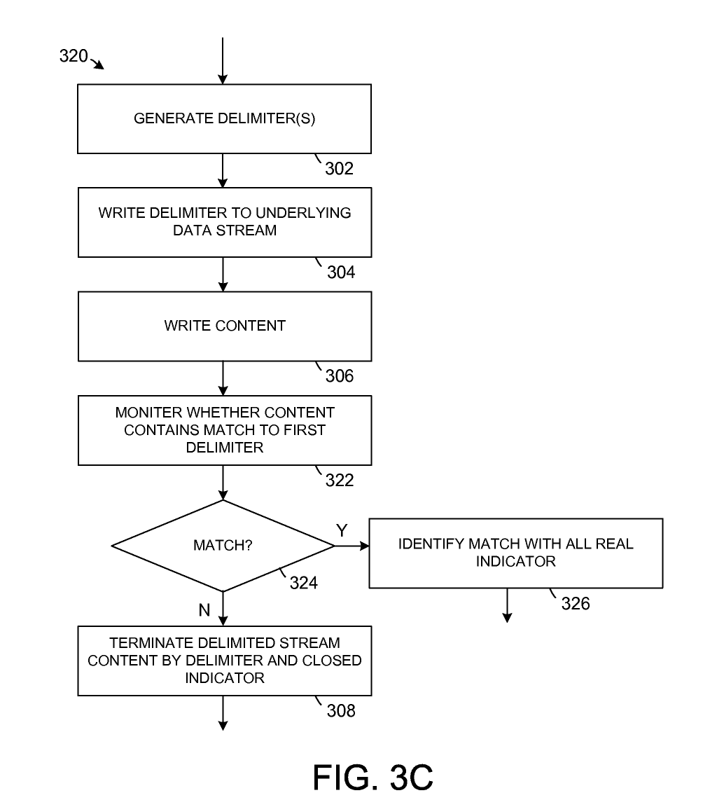

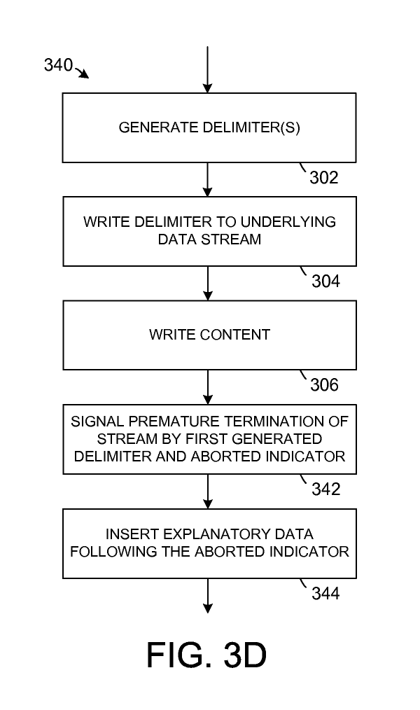

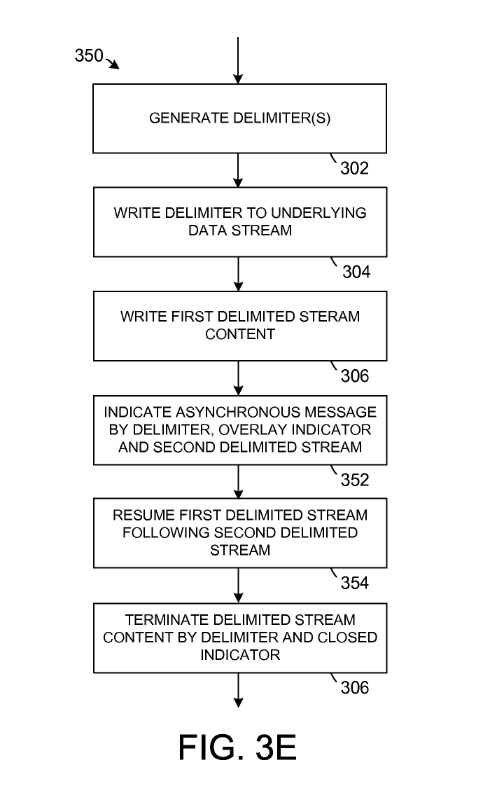

Referring to FIGS. 3A through 3E, multiple flow charts depict aspects and embodiments of methods for managing data communication. FIG. 3A is a flow chart illustrating an embodiment of a method 300 for managing data communication. The method 300 comprises generating 302 a delimiter, writing 304 the generated delimiter to an underlying data stream, and then writing 306 content. The delimited stream is terminated 308 by the generated delimiter followed by a CLOSED indicator. The methods can be executed, for example, by the server or clients depicted in FIG. 1.

In some embodiments or applications, as shown in FIG. 3B, a communication method 310 can further comprise nesting 312 a second delimited stream within a first delimited stream. Nesting 312 the second delimited stream can comprise generating a second delimiter in the operation for generating 302 delimiters, and writing 314 the second generated delimiter as a prefix. Content of the second delimited stream is written 316, then terminated 318 by the second delimiter followed by a CLOSED indicator.

Referring to FIG. 3C, a schematic flow chart depicts another embodiment of a communication method 320 further comprising actions of monitoring 322 whether the delimiter stream contains a data content sequence that matches the first delimiter. Whenever the data content sequence matches the first delimiter 324, the data content sequence is identified 326 as matching the first delimiter by appending to it an ALL REAL indicator which is not considered data content in the delimited stream.

Referring to FIG. 3D, a method 340 for managing communication using delimited streams can further comprise signaling 342 premature termination of the delimited stream by the first delimiter followed by an ABORTED indicator. In some embodiments this may be followed by inserting 344 explanatory data (for example, a numeric code) following the ABORTED indicator in a format known to the reader. This explanatory data may take the form of a second delimited stream with its own delimiter.

Referring to FIG. 3E, a schematic flow chart depicts another embodiment of a communication method 350 further comprising actions of indicating 352 an asynchronous message in the first delimited stream by the first delimiter followed by an OVERLAY indicator followed by a second delimited stream using a second generated delimiter. Data content of the first delimited stream is resumed 354 following the second delimited stream.

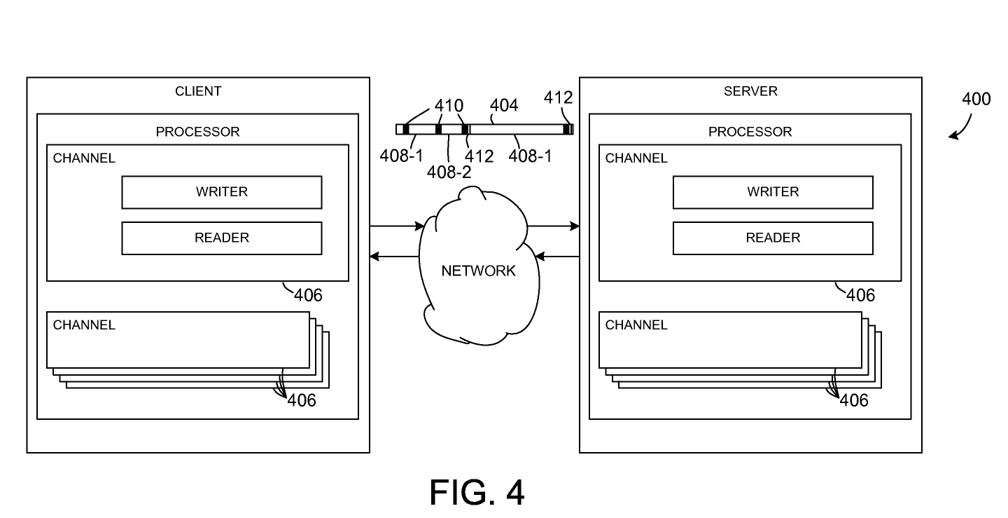

Referring to FIG. 4, a schematic block diagram illustrates another embodiment of a communication system 400 which supports nestable delimited streams with abort and overlays. The communication system 400 comprises a communication channel 406 that communicates a data stream 404 in multiple delimited streams 408. The individual delimited streams 408 are delimited by a prefix formed of a delimiter 410 which is generated specific to the delimited stream 408 and a postfix formed of the generated delimiter 410 followed by a CLOSED indicator 412. The communication channel 406 nests a second delimited stream 408-2 within a first delimited stream 408-1 of the multiple delimited streams 408.

Embodiments of the communication system 100 and 400 can be implemented in Java using Java's notion of streams, which are instances of classes used to read and write data. Some Java stream classes read and write directly to files or to processes, while others classes read and write to other stream instances. Other embodiments may be implemented on other platforms and it is not required that both sides of a communication channel communicating delimited streams be implemented in the same language or using the same classes. Similar functionality can be implemented in essentially any language. While an illustrative embodiment describes an implementation in terms of streams that deal with bytes, nothing precludes implementations that use other elements (such as 2- or 4-byte integers or characters or partial bytes) as the basic level.

The illustrative Java model is described in terms of functionality for wrapping an underlying stream such as a socket or a file writer, but can certainly be implemented to define basic behavior for streams in a system. The illustrative Java model also supports the basic InputStream and OutputStream behavior for reading and writing bytes and arrays of bytes. More complex behavior (such as dealing with integers wider than a byte, character strings, or lines of text) is implemented by classes that wrap or derive from the basic InputStream and OutputStream behavior. The behavior can also be implemented as part of a more robust class with additional functionality. However, definite advantages are gained by limiting the configuration to a minimal class implemented as a wrapper, most notably to enable wrapping of many different kinds of strings and wrapping the minimal class by many different classes to enable different extensions.

Output Stream

In the illustrative model, a delimited stream is constructed by an instance of the DelimitedOutputStream class, which upon construction is associated with OutputStream object which is the object used to construct the delimited stream's underlying data stream. All output by the DelimitedOutputStream will be by means of this OutputStream object.

An aspect of operation is that each delimited stream (and each nested delimited stream) has an associated randomly generated delimiter. When an output stream is created, some random (or more likely pseudo-random) technique is used to generate a delimiter of a predetermined width (such as number of bytes). Typically the number of bytes is predetermined and known to both sides. Three or four bytes are likely good choices. For smaller than three bytes, excessive collisions occur. For larger than four bytes, space is likely wasted.

Random generation of the delimiter does not have to be in any sense cryptographically strong. What is sought is not unpredictability or even irreversibility, just a reasonable distribution of bytes. In principle any bytes can be used in the delimiter, but substantial simplification is gained if the first byte is different from all of the others, for example accomplished simply by checking each subsequent byte and incrementing the byte or generating a new byte if equal to the first byte. If the range of bytes expected to be written to the stream is known, advantage is gained by having the bytes of the delimiter (or, at least, the first byte) to be unlikely within the expected range. For example, if the stream is likely to contain mainly ASCII or ISO Latin-1 text, the first character of the delimiter can be selected from the numbers 128-255 (or even some more restricted subrange) to improve efficiency. In most cases, arbitrary binary data can be expected so all bytes should be eligible. However if known that the underlying stream has a particular fixed delimiter, selection of the delimiter can be avoided.

Once chosen, the delimiter is written onto the underlying stream. If the width of the delimiter is not fixed ahead of time but chosen when the stream is created, the delimiter width is written first. In a specific example, if the delimiter width is three bytes and the randomly-generated delimiter is “TQS” and the reader cannot be assumed to predict that the delimiter is three characters, the stream can start with “\03TQS”, where “\03” is the Java and C++ notation for the character with a numeric value of 3. Although the examples herein are confined to the printable ASCII range for ease of reading, usually at least some of the characters may not be included in from the range. Other encoding schemes can be used to overlay the indication of the delimiter width on the delimiter.

The DelimitedOutputStream class inherits from OutputStream, so the user of a DelimitedOutputStream typically simply writes to it as if it were an OutputStream, typically after wrapping delimited class with some other class that has a simpler API. For example, functionality is depicted considering the following code:

```
Void marshal(OutputStream s) throws IOException
{
  try {
    OutputStream dos = new DelimitedOutputStream(s);
    DataOutput out = new DataOutputStream(dos);
    out.writeUTF(this.name);
    out.writeUTF(this.message);
  } finally {
    dos.close( );
  }
}.
```

The original stream s (which may be a DelimitedOutputStream), is wrapped by a created DelimitedOutputStream, which is then simply treated as an OutputStream. The stream s is then wrapped by a DataOutputStream object which provides methods to write numbers and strings, but which only expects the underlying stream to be able to accept bytes and arrays of bytes. The method then writes two strings and closes the DelimitedOutputStream. The call to close( ) is within a “finally” block to ensure that the stream is closed even if the method exits because an exception created by something called by the method passed through the stream. The close ( ) is unnecessary in many cases, but is good programming practice. In C++, the creation and close can be encapsulated in a wrapper object that is put on the stack, to the same effect.

The strings when written onto the DelimitedOutputStream (by way of the DataOutputStream wrapper) are in fact written to the underlying stream (s), with care taken to handle the unusual case in which the delimiter happens to appear in content written onto the DelimitedOutputStream, including content that arises due to delimiters and indicators due to DelimitedOutputStreams nested within the content. Logic that handles the occurrence of the delimiter within the data stream is discussed below. When the DelimitedOutputStream is closed, the delimiter is written to the underlying stream followed by a byte that indicates CLOSED. The CLOSED indicator is depicted using “C” for illustrative purposes, but may (as with other indicators) be any byte and need not be printable.

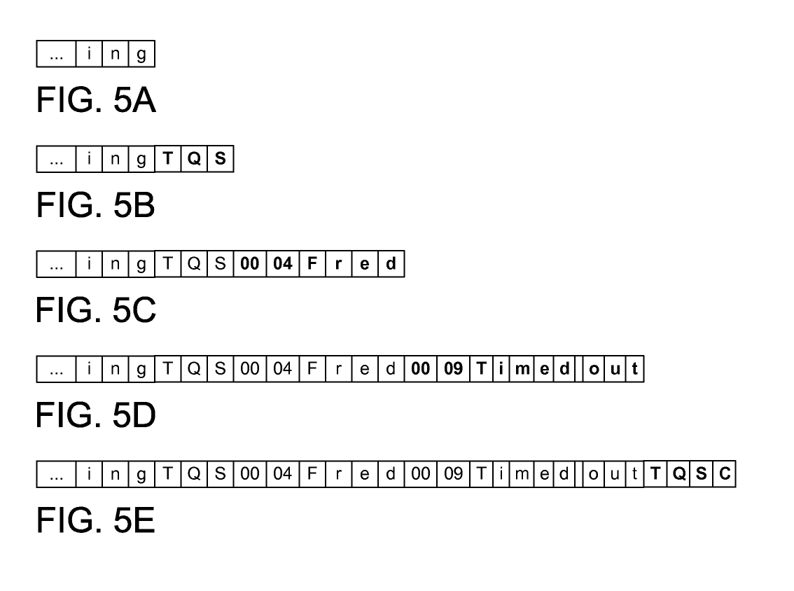

Referring to FIGS. 5A through 5E, data diagrams show a series of data values in a data stream (the underlying data stream for a delimited stream) in an example operation. For purposes of example only, the delimiters can be assumed to be three-bytes wide and the selected delimiter is “TQS”. Sequencing through the example, when marshal( ) is called, the end of the content of data stream s is shown in FIG. 5A. After the DelimitedOutputStream is created, the data stream s is extended by the delimiter as shown in FIG. 5B. After writing the name “Fred”, the data stream s takes the form depicted in FIG. 5C. DataOutputStream's writeUTF( ) method writes the number of characters before the UTF-8 representation of the characters. FIG. 5D shows the stream s after writing the message “Timed out”. FIG. 5E shows the stream s after closing the stream.

The implementation includes no overhead to the user other than creating the DelimitedOutputStream object. The overhead in terms of bytes sent is two copies of the delimiter (one at the beginning and one at the end) plus one byte to signal that the stream is closed, for a total of seven bytes. When the delimited stream is closed, the underlying stream is not, so that more data can be sent on the stream.

In the rare case in which the delimiter is actually contained in the data being written, the delimiter is followed (not, as in most systems, preceded) by a distinguished byte, depicted in this case as “A” for ALL REAL. The operation also occurs transparently, to both the reader and the writer. Since each delimited stream has a specific associated randomly-generated delimiter, when the streams are nested, more byte sequences have the extra byte appended. Except in highly exceptional cases, adding more than one such byte to a given sequence is unwarranted.

In such a highly exceptional case, one stream is nested in another with both having the same delimiter. If both have delimiters “DEL” and the ALL REAL byte is “A”, then the sequence “DEL” is encoded as “DELAA”. The highly exceptional case would also occur if the inner stream has delimiter “DEL” and the outer stream has delimiter “ELA”. Other cases can result in the same phenomenon. Actions can be taken to avoid the exceptional case by extra bookkeeping when choosing delimiters, but the case so sufficiently rare and the cost so sufficiently slight that the actions are likely superfluous.

In a specific example embodiment, DelimitedOutputStream can have three principal externally-visible methods for writing data including a constructor, write a byte, and close. A DelimitedOutputStream object can also contain data including a reference to an OutputStream object for writing to the underlying stream, the delimiter (for example, as an array of bytes), a “position in delimiter” (PID) indicator, and a Boolean indicating whether the stream has been closed.

The DelimitedOutputStream, when constructed, is supplied with an OutputStream object, which it will use to write to the underlying stream. The DelimitedOutputStream object generates a random delimiter, taking care that the first byte be different from subsequent bytes, and sets the PID value to zero and notes that stream has not been closed. The DelimitedOutputStream object writes the associated delimiter to the underlying stream.

When the stream is closed, the DelimitedOutputStream object first checks to determine whether the stream has already previously been closed. If not, the DelimitedOutputStream object writes the associated delimiter to the underlying stream followed by the CLOSED byte and notes that the stream is now closed.

When the stream is requested to write a byte, the DelimitedOutputStream object first checks to see whether the stream has already been closed. If so, the DelimitedOutputStream object may (in various embodiments) throw an exception, return an exceptional value, or simply drop the request. A given DelimitedOutputStream does not write data to the underlying stream once indication has been written that the stream is closed.

If the stream has not been closed, first the byte is written to the underlying stream. Then the method checks the delimiter and the PID value. The PID value is an index into the delimiter array and represents the byte that would be the next byte in a delimiter sequence in data. The PID value starts at zero, indicating that the DelimitedOutputStream is looking for the first byte of the delimiter. In the illustrative example, the delimiter is “TQS” and a PID value of zero indicates that the DelimitedOutputStream is looking for a “T” byte. A PID value of one indicates that a “T” has just been detected and determination of whether the next value is a “Q” is made. A PID value of two means that “TQ” has just been detected and determination of whether the next byte is “S” is performed.

So when a byte is written, the write( ) method (for example) can be used to check whether the byte matches the one at the position in the delimiter indicated by PID. If so, PID is incremented. If incrementing PID results in a value equal to the length of the delimiter, then all of the delimiter bytes have been matched, the ALL REAL byte is written to the underlying stream, and PID is reset to zero.

Otherwise, if the byte does not match the appropriate byte in the delimiter, then any partial prefix seen can be ignored. One further check is made to ensure that the new character is not the start of a delimiter. If the byte that is written is equal to the first byte of the delimiter, PID is set to 1, indicating that one character has been matched, otherwise PID is set to zero. To avoid checking twice, this further check may be omitted when no match was found when PID was equal to zero.

Two further methods can be involved in writing data. In a first method output streams also supply a method for writing arrays of bytes at a time, which can often be much more efficient than calling methods one byte at a time. In Java, if a special method is not supplied, the operation defaults to calling the single-byte write, which results in single-byte writes on the underlying stream. Thus definition of a special method is likely worthwhile for handling byte array writes in terms of byte array writes on the underlying stream. The illustrative first method receives three parameters including a byte array, the position in the byte array at which to start (“start”), and the number of bytes to write (“nbytes”). After checking to ensure that the parameters are valid, the DelimitedOutputStream's implementation can operate in a straightforward manner wherein a pointer is walked through the array from start to start+nbytes, using the PID to detect matches with the delimiter as described above. If PID ever reaches the length of the delimiter (for example, if a complete delimiter is ever matched), the underlying stream's array write is called with the same array, starting from the start position and going through the matched delimiter. Then the ALL REAL byte is written to the underlying stream, PID is reset to zero, start is updated to point past the matched delimiter, and the loop continues. When the loop is finished, if start is before the end position of the subarray to be written, the remaining bytes are written to the same underlying stream as an array write. Typically, a single pass is made through the data confirming that no delimiters are present in the stream and a single array write is made to the underlying stream.

A second example method performs a write using a flush( ) operation and may be used to enable the caller to ensure that all bytes written up to a particular point are written to the final destination (for example, a file or remote process) immediately. Most wrapper classes can simply implement flush( ) by calling flush( ) on the underlying stream. However, as shown hereinafter, such an implementation does not ensure that, as data is read from a delimited stream, the reader would be able to read the last bytes if the bytes represent a partial delimiter. Instead, a first check can be performed to detect whether PID is greater than zero, indicating partial matching to a delimiter. If not, the underlying stream can be flushed and a return made. Otherwise, a partial delimiter can be completed and written to the underlying stream. In the illustrative example, if the last character is “T” (signaled by PID=1), then “QS” can be written to the underlying stream. If the last two characters are “TQ” (signaled by PID=2), the “S” is written. Then an indication of how many bytes of the delimiter are “real” can be written. In the most general case, the N REAL byte can be written followed by a byte giving a count. Since most delimiters are short, special bytes indicating ONE REAL, TWO REAL, and THREE REAL can be defined. Then PID is reset to zero and the underlying stream is flushed.

### Input Stream

In a reader of the communication channel, the class DelimitedInputStream can be used which inherits from InputStream and therefore provides a read( ) method and a close( ) method. The read( ) method reads a byte and generates an indication if the end of file has been reached. The close( ) method consumes and ignores any remaining bytes, positioning the underlying stream to read what follows. A DelimitedInputStream object is constructed to be associated with an InputStream object to be used to read from the delimited stream's underlying data stream.

When constructed on an underlying stream, a DelimitedInputStream first reads the delimiter from the underlying stream, in some embodiments prefixed by the number of bytes in the delimiter. In addition to the delimiter, a DelimitedInputStream keeps track of whether the stream is closed, stream status (which may be one of LIVE, IN DELIMITER, or IN PEEK), an indication of whether the stream has a “peeked byte” and, when it does, the peeked byte, a count of delimiter characters matched, and index of the next delimiter character to be matched. Status is initially set to LIVE with the stream not closed and no peeked byte.

When asked to read a byte, the DelimitedInputStream first checks to determine whether the stream is considered to be closed. If so, the DelimitedInputStream returns an end-of-file indication. Otherwise, if in the normal case of LIVE status, the DelimitedInputStream reads a byte from the underlying stream. If the byte is not equal to the first byte of the delimiter, the DelimitedInputStream simply returns the read byte. Otherwise the DelimitedInputStream calls readDelimiterPrefix( ) which resets and returns status and usually other values.

If the status is IN PEEK, the “peeked byte” is the next byte read. If the byte is the same as the first character of the delimiter, the DelimitedInputStream returns the value of readDelimiterPrefix( ). Otherwise, the DelimitedInputStream sets its status to LIVE and returns the value of the peeked byte.

Otherwise, the status is IN DELIMITER, which indicates that all or part of a delimiter (in readDelimiterPrefix( ) has been read but the delimiter data actually is part of the data. If so, the amount of delimiter matched has been tracked. The bytes of the prefix are written one by one, so the index of the next byte of the prefix to return is tracked. When requested to read a byte when status is IN DELIMITER, the DelimitedInputStream returns the next byte from the prefix. Before doing so, the index of the next byte is incremented. If the index is equal to the length of the matched prefix, then the entire prefix has been returned. If so and if the stream has a peeked byte (a data byte following the prefix), the status is changed to IN PEEK. Otherwise the status is changed to LIVE.

The read DelimiterPrefix( ) function is called whenever the next byte read in LIVE status or the peeked byte in IN PEEK status matches the first byte of the delimiter. The read DelimiterPrefix( ) function reads subsequent bytes until a mismatch for the delimiter is found (starting with the second byte, since the first has already been matched) or until the entire delimiter is matched. If a mismatch is found, the mismatching byte becomes the peeked byte and presence of the peeked byte is indicated. The byte returned (which is returned from read( ) is the first byte of the delimiter. If only the first byte was matched (that is, if readDelimiterPrefix failed to match any further delimiter bytes), the status is set to IN PEEK. Otherwise, readDelimiterPrefix( ) keeps track of how many bytes were matched, sets the status to IN DELIMITER, and sets the index of the next byte to 1, indicating that the next byte to be returned is be the second byte.

In a less-preferred embodiment readDelimiterPrefix( ) can always return an IN DELIMITER status, even if only one delimiter byte was matched, on a partial match or a full, but “accidental” match.

If readDelimiterPrefix( ) matches the entire delimiter, the next “control” byte can be read and action taken based on the control indication. If the byte is CLOSED, the stream is marked as closed and an end-of-file indication returned. In an example implementation, the Java convention of returning −1 as an integer value is followed. If the indicator or control byte is ALL REAL, ONE REAL, and the like, the number of “real” bytes is noted (in the case of N REAL, the following byte is read. If the number is one, the status is set to LIVE. Otherwise, the status is set to IN DELIMITER, the number of bytes matched is set to the number of real bytes, and the next byte to return is set to 1. In any case, the first byte of the delimiter is returned. Operation of other control bytes is disclosed hereinafter.

The close( ) method simply consumes all remaining bytes by calling read( ) until an end-of-file indication is returned, a process that may involve processing aborts and overlays. In some embodiments, having the DelimitedInputStream suppress the processing of overlays and/or aborts during a close may be desirable. If so, when an overly and/or abort is detected during a close, the DelimitedInputStream created to handle them as described below is simply closed immediately without searching for a handler.

Delimited Streams for Sending Collections

One advantage of the delimited approach is that variable-sized data can be sent without addressing pre-computation of the size or even (for the case of arrays, sets, and the like) how many elements are present. In an example scenario, as part of the return value from a call, a server may attempt to send elements of a set of pages that are valid, but a count of the valid elements is unavailable. Thus in an example code:

```
OutputStream dout = new DelimitedOutputStream(out);
try {
  for (Page p : contents) {
    if (p.isValid( )) {
      p.writeTo(dout);
    }
  }
} finally {
  dout.close( );
}.
```

On the client side, the code is as simple:

```
InputStream din = new DelimitedInputStream(in);
Set<Page> set = new HashSet<Page>( );
try {
    Page p;
      while ((p = Page.readFrom(din)) != null) {
        set.add(p);
      }
} finally {
  din.close( );
}.
```

Aborting

Another feature of delimited streams is that the streams are abortable. Aborting a stream is similar to throwing an exception in a programming language, but the handling takes place on the receiver's side. Aspects of aborting a stream include:
(1) A delimiter is written to the underlying stream, followed by a control byte indicating the abort.
(2) The DelimitedOutputStream is marked as being closed, meaning that any further writes to the stream will fail. In an example implementation, an exception can be raised.
(3) A new DelimitedOutputStream is created on the same underlying stream.
(4) The source of the abort of the stream passes a DelimitedOutput Stream.Writer object, which implements a write( ) method used to describe the reason for the abort. The write( ) method is called with the new DelimitedOutputStream as an argument. When the write( )method returns or throws an exception, the new DelimitedOutputStream is closed.

On the reader side
(1) The delimiter is read (in readDelimiterPrefix( ) and an ABORTED control byte is detected.
(2) The DelimitedInputStream is marked as being closed. Any further reads are treated as reads past end-of-file.
(3) A new DelimitedInputStream is created on the same underlying stream.
(4) The first DelimitedInputStream checks for a DelimitedInput Stream.Reader object registered as an abort handler. If the object is present, the read( ) method for the object is called with the new DelimitedInputStream as an argument. If not, or when the method returns or throws an exception, the new DelimitedInputStream is closed.
(5) When the abort handler is finished, the call to read( ) that resulted in detection of the abort returns the end-of-file indication.

The illustrative example implementation is very general. Writers can write anything as the abort description and DelimitedInputStreams have at most a single registered handler that reads and acts on what is written. In other implementations, various specialized techniques for communicating between writers and readers may be used. In some embodiments, the communication techniques may be built into the fundamental behavior for aborting and finding handlers.

In many cases, the writer can begin by writing an indication of the reason for the abort. The reason may often take the form of a number or a string and may be followed by some textual description for the benefit of implementations that do not have prior information regarding the particular reason. The textual information can be logged for subsequent usage or displayed to a user. The textual description can be followed by any particular data pertinent to the abort. On the reader side, the general abort handler can read the code and then inquire within a table to determine whether a more specific abort handler is registered to deal with the abort. If so, the reader delegates handling to that more specific handler. If not, the reader continues handling the abort, calls a default abort handler, or drops the abort. No difficulty arises if no abort handler is available that can handle the abort data. If no abort handler is found or the executing abort handler exits or throws an exception, the abort stream is closed, which skips over any unconsumed bytes.

In some cases, exceptions may be used in conjunction with aborts to simplify control flow. On the writer side, the abort may be folded into an exception handler for a try block created just after the DelimitedOutputStream. An example code implementation may be, as follows:

```
DelimitedOutputStream out = new DelimitedOutputStream(s);
try {
    handler.process(out);
} catch(NoSuchObjectException e) {
    out.abort(new NoSuchObjectAbortWriter(e));
} finally {
  out.close( );
}.
```

Even though the abort( ) will call close( ) (or otherwise cause the DelimitedOutputStream to be marked as being closed), an acceptable for variation is to be called again in the finally block if an exception is caught. Calling close( ) multiple times has no effect.

Accordingly, all dealing with aborting can be encapsulated into the caller of process( ), which merely includes functionality to create and throw a NoSuchObjectException when relevant. Another advantage to such encapsulation of abort handling is that the handler object can operate independently of DelimitedOuputStreams and thus can treat the argument to process( ) as simply an OutputStream.

The reader can handle termination of the abort by throwing an exception, in some cases after finding and requesting a more specific reader to construct an exception, which the more general reader throws.

One asymmetry between the writer and reader of an abort is that the writer supplies an arbitrary callback object to write the data but the reader previously has registered handlers to recognize and deal with the abort. The reader registers the abort handler by explicitly calling a registerAbortHandler( ) method of some type. In many cases the actual delimited input streams created are instances of subclasses of DelimitedInputStream with constructors that register the appropriate handler and which may have, for example, tables of more specific handlers. One possible concern is construction of the DelimitedInputStream used to read the abort data, which may be problematic because this stream can be aborted as well, and thus has specifically associated handlers. Thus, the stream (or possibly the registered abort handler) likely will use an overridable method for constructing the abort stream.

The embodiment disclosed hereinabove has the original stream considered closed following the ABORTED control byte and a new stream constructed to follow. The arrangement is highly useful, but two other possible example embodiments are:
(1) Nesting the abort stream within the original delimited stream, following the delimiter and CLOSE for the abort stream with the delimiter and CLOSE for the original stream. Disadvantages of nesting the abort stream include overhead of the unnecessary extra bytes due to additional opportunities presented for collisions (with two delimiters), and resulting because the abort stream has to delegate to the original delimited stream for all write (and read) operations rather than delegating directly to the underlying stream.
(2) Using the same delimited stream. Thus, a new delimited stream is not constructed. Writes are mode to the old delimited stream, which is closed when the write returns. If the same delimited stream is used, a few bytes are saved since no new delimiter is written at the expense of at least two disadvantages. One disadvantage is that the handlers for the original stream and the abort stream are necessarily the same, which may be an advantage in some systems. Another disadvantage is that care must be taken in both the reader and writer that non-abort data is not written to or read from the streams following the abort. With separate delimited streams, no problem occurs since the original stream is closed, and so attempts to write to and read from the original stream will fail.

In some embodiments, abort behavior may be limited to simply notifying of the abort without writing any data. Thus, no new stream (and therefore no writer or reader) are created, but a handler is still present on the input stream. Otherwise, abort( ) would be identical to close( ). In some embodiments, the ABORTED indicator may be followed by explanatory data (as, for example, a numeric code) in a format known to the DelimitedInputStream. In such an embodiment, the DelimitedInputStream could declare itself closed, read the data, identify an abort handler, and call the handler with the explanatory data as an argument.

Overlays

Overlays are very similar to aborts. On the writer side, a method is called, passing in a callback Writer object which writes data to a new delimited stream. On the reader side, a handler is found which reads data from a new delimited stream and closes (skips past the end of) the new stream when complete.

The primary differences between overlays and aborts include:
(1) A different indicator or control byte is used (OVERLAY rather than ABORTED).
(2) The overlay delimited stream is nested within the original delimited stream, which is not closed, so once the overlay has been processed (or skipped because no handler was found), further data can be read from the original stream.
(3) Once the overlay handler is finished and the overlay stream is closed (and therefore all the data is consumed), the read( ) method is called recursively to get the next byte, which is returned.

Because the original stream is not closed, data is prevented from being written to the original stream while the overlay is written or read from the original stream while the overlay is read, a constraint for any nested stream. Since the call to read( ) is blocked until the handler returns (unless a thread is spawned, which should not happen until the data is consumed and the overlay stream closed), any such reads occur either within the overlay handler or in a different thread and reads to the same stream from multiple threads are usually improper unless extreme care and much synchronization are used. The writing constraint of nested streams can be implemented by having the stream note that the stream is in the middle of writing or reading an overlay and have any direct calls to write( ) or read( ) throw an exception to that effect. If detected that such calls are in a different thread from the reader or writer invocation, a sufficient implementation can be to have the calls block until the overlay is finished, which may lead to deadlock in some situations.

In another example configuration, multiple overlays can be active on the same stream at the same time. The semantics can be as follows:
(1) Overlay( ) is called on DelimitedOutputStream S, creating nested DelimitedOutputStream O1.
(2) Overlay( ) is called again on DelimitedOutputStream S, perhaps asynchronously, creating nested DelimitedOutputStream O2, nested within S, but not O2. Care is taken to not write to O1 while the writer is writing to O2. (If the overlay is synchronous with the first overlay, no problem occurs but a possibly better action is to assert the second overlay on O1 rather than on S to enable proper nesting (O2 on O1 on S). Some situations may occur in which the source asserting the overlay has knowledge of S but not O1.
(3) On the reader's side, S.read( ) is called and an OVERLAY control byte is noticed, followed by the beginning of O1. A handler is found and dispatched.
(4) At some point within the handler, O1.read( ) is called, which calls S.read( ) and an OVERLAY control byte is noticed, followed by the beginning of O2. A second handler is found and dispatched.
(5) The second handler finishes, and the delayed (nested) call to S.read( ) returns, allowing the first handler to proceed.
(6) The first handler finishes, and the original delayed call to S.read( ) returns.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A method for communicating data between devices in a data communication system comprising:
generating a delimited-stream-specific delimiter;
indicating a beginning of a delimited stream in a data stream by writing in the data stream the delimited-stream-specific delimiter;
writing content of the delimited stream to the data stream; and
terminating the delimited stream by writing in the data stream the delimited-stream-specific delimiter followed by an indicator of end of the delimited stream.

2. The method according to claim 1 wherein the delimited-stream-specific delimiter is a first delimiter, the delimited stream is a first delimited stream, and the indicator of end of the delimited stream is an indicator of end of the first delimited stream further comprising:
generating a second delimiter;
indicating the beginning of a second delimited stream in the content of the first delimited stream by writing in the first delimited stream the second delimiter; and
writing content of the second delimited stream to the first delimited stream; and terminating the second delimited stream by writing in the first delimited stream the second delimiter followed by a second indicator of end of the delimited stream.

3. The method according to claim 1 further comprising:
discovering that the content of the delimited stream contains data content that matches the delimited-stream-specific delimiter; and
communicating the matched data content by writing to the data stream the delimited-stream-specific delimiter followed by an ALL REAL indicator.

4. The method according to claim 1 further comprising:
discovering that the content of the delimited stream contains data content that matches a prefix of the delimited-stream-specific delimiter; and
communicating the matched data content by writing to the data stream the delimited-stream-specific delimiter followed by an indicator indicating length of the prefix.

5. The method according to claim 1 further comprising:
discovering premature termination of the delimited stream; and
indicating the premature termination by writing to the data stream the delimited-stream-specific delimiter followed by an ABORTED indicator indicating that the delimited stream is prematurely terminated.

6. The method according to claim 5 further comprising:
writing to the data stream, following the ABORTED indicator that the delimited stream is prematurely terminated, explanatory content indicating a reason for the premature termination.

7. The method according to claim 6 wherein the delimited-stream-specific delimiter is a first delimiter and the delimited stream is a first delimited stream further comprising:
configuring the explanatory content as a second delimited stream within the data stream using a second generated delimiter.

8. The method according to claim 1 wherein the delimited-stream-specific delimiter is a first delimiter and the delimited stream is a first delimited stream further comprising:
communicating an asynchronous message in the first delimited stream comprising:
writing to the data stream the first delimiter followed by an OVERLAY indicator;
writing to the first delimited stream a second delimited stream using a second generated delimiter; and
resuming data content of the first delimited stream following the second delimited stream.

9. The method according to claim 1 further comprising:
generating the delimited-stream-specific delimiter within a delimited stream writer;
writing content of the delimited stream to the data stream in response to requests made on the delimited stream writer wherein processing the requests comprises discovering matches between written data content and the delimiter; and
terminating the delimited stream in response to a close request made on the delimited stream writer.

10. A method for communicating data comprising:
beginning reading a delimited stream in a data stream by reading a delimited-stream-specific delimiter from the data stream;
continuing to read data from the data stream, monitoring for matches with the delimited-stream-specific delimiter;
treating unmatched data read as content of the delimited stream; and
interpreting a match of the delimiter followed by an indicator indicating end of the delimited stream.

11. The method according to claim 10 wherein the delimited-stream-specific delimiter is a first delimiter, the delimited stream is a first delimited stream, and the indicator indicating end of the delimited stream is a first indicator indicating end of the delimited stream further comprising:
beginning reading a second delimited stream in the content of the first delimited stream by reading a second delimiter from the first delimited stream;
continuing to read data from the first delimited stream while monitoring for matches with the second delimiter;
treating unmatched data read as content of the second delimited stream; and
interpreting a match of the second delimiter followed by a second indicator indicating end of the second delimited stream.

12. The method according to claim 10 further comprising:
interpreting a match of the delimited-stream-specific delimiter followed by an ALL REAL indicator indicating that the matched delimiter is real data content of the delimited stream.

13. The method according to claim 10 further comprising:
interpreting a match of the delimited-stream-specific delimiter followed by an indicator indicating length of a prefix as indicating that content of the delimited stream contains a prefix of the delimited-stream-specific delimiter, the prefix having the indicated length.

14. The method according to claim 1 further comprising:
interpreting a match of the delimited-stream-specific delimiter followed by an ABORTED indicator as indicating a premature termination of the delimited stream;
determining the delimited stream includes no more data content; and
identifying an abort handler.

15. The method according to claim 14 further comprising:
reading from the data stream explanatory content indicating a reason for the premature termination; and
using the abort handler to process the explanatory content.

16. The method according to claim 15 wherein the delimited-stream-specific delimiter is a first delimiter and the delimited stream is a first delimited stream further comprising:
reading the explanatory content as a second delimited stream using a second generated delimiter.

17. The method according to claim 10 further comprising:
creating a delimited stream reader;
reading the delimited stream from the data stream within the delimited stream reader in response to requests made on the delimited stream reader, wherein processing the request comprises monitoring for matches between read data content and the delimited-stream-specific delimiter and wherein action taken in response to detecting a match is contingent upon value of an indicator subsequently read from the data stream;
responding to a CLOSED indicator comprising determining that the delimited stream includes no more data content;
responding to an ALL REAL indicator comprising determining that content of the first delimited stream contains the match;
responding to an ABORTED indicator comprising:
determining the delimited stream includes no more data content;
identifying an abort handler; and
using the abort handler to process explanatory content regarding a premature termination of the delimited stream; and
responding to an OVERLAY indicator comprising:
identifying an overlay handler; and
using the overlay handler to process an asynchronous message in the delimited stream;
wherein the delimited stream reader object responds to a closure request by processing content in the first delimited stream until the delimited stream reader object determines that the first delimited stream includes no more data content.

18. An article of manufacture comprising:
a controller-usable medium having a computer readable program code, the computer readable program code further comprising:
code causing a controller to send a data stream comprising a plurality of delimited streams, ones of the plurality of delimited streams delimited by a prefix of a delimiter generated specific to the delimited stream and a postfix of the generated delimiter followed by an indicator of end of the delimited stream; and
code causing the controller to nest a second delimited stream within a first delimited stream of the plurality of delimited streams.

19. The article of manufacture according to claim 18 further comprising:
code causing the controller to write the data stream;
code causing the controller to generate a first delimiter;
code causing the controller to indicate the beginning of a first delimited stream in a data stream by writing in the data stream the first delimiter;
code causing the controller to write content of the first delimited stream to the data stream;
code causing the controller to generate a second delimiter;
code causing the controller to indicate beginning of a second delimited stream in the content of the first delimited stream by writing in the first delimited stream the second delimiter;
code causing the controller to write content of the second delimited stream to the first delimited stream;
code causing the controller to terminate the second delimited stream by writing in the first delimited stream the second delimiter followed by a second indicator of end of the delimited stream; and
code causing the controller to terminate the first delimited stream by writing in the data stream the first delimiter followed by a first indicator of end of the delimited stream.

20. The article of manufacture according to claim 18 further comprising:
code causing the controller to read a data stream;
code causing the controller to begin reading a delimited stream in a data stream by reading a delimiter from the data stream;
code causing the controller to continue to read data from the data stream while monitoring for matches with the delimiter;
code causing the controller to treat unmatched data read as content of the delimited stream; and
code causing the controller to interpret a match of the delimiter followed by an indicator indicating the end of the delimited stream.
